(19) United States
(12) Patent Application Publication
(10) Pub. No.: US 2009/0175461 A1
(43) Pub. Date: Jul. 9, 2009

(54) ACTIVE NOISE CONTROLLER

(75) Inventors: Yoshio Nakamura, Osaka (JP); Toshiyuki Funayama, Osaka (JP); Tsukasa Matono, Osaka (JP)

Correspondence Address: RATNERPRESTIA, P.O. BOX 980, VALLEY FORGE, PA, 19482, US

(73) Assignee: PANASONIC CORPORATION, Osaka (JP)

(21) Appl. No.: 12/297,965

(22) PCT Filed: Jun. 5, 2007
(86) PCT No.: PCT/JP2007/061371

§ 371 Date: Oct. 21, 2008

(30) Foreign Application Priority Data
Jun. 9, 2006 (JP) 2006-160483

(51) Int. Cl. G10K 11/16

(52) U.S. Cl. 381/71.1

(57) ABSTRACT

In an active noise reduction apparatus with an adaptive notch filter used, a triangle wave as a reference signal input into a first coefficient updater and a second coefficient updater reduces the number of execution times of product-sum operations in a reference signal generator to reduce the operation load.

### TECHNICAL FIELD

The present invention relates to an active noise reduction apparatus actively reducing vibration noise generated from a rotating machine such as an engine on a vehicle.

### BACKGROUND ART

In a conventional active noise reduction apparatus, a method is known of performing adaptive control with an adaptive notch filter (refer to patent literature 1 for example).

FIG. 7 is a block diagram illustrating the configuration of a conventional active noise reduction apparatus described in patent literature 1. In FIG. 7, a discrete operation for implementing an active noise reduction apparatus is executed by discrete operation processing unit 115. Engine rotation speed detector 101 outputs as engine pulses p, a pulse string with its frequency proportional to the rotation speed of the engine. Engine pulses p are produced by extracting output from a crank angle sensor, for example. Frequency detector 102 calculates noise frequency f according to engine pulses p and outputs the frequency. Reference signal generator 116 has sine wave table 103 retaining on a memory values at respective points given by equally dividing one cycle of sine wave by a predetermined number. Selecting unit 117 selects data from sine wave table 103 and generates reference sine-wave signal x1[n] and reference cosine-wave signal x2[n] with their frequency equal to noise frequency f and outputs the signals.

Reference signal generator 118 uses reference sine-wave signal correction value table 119 (the reference sine-wave signal correction value at frequency f (Hz) is represented as C1[f]) and reference cosine-wave signal correction value table 120 (the reference cosine-wave signal correction value at frequency f (Hz) is represented as C2[f]), both simulating transmission characteristic values of from speaker 110 to microphone 111, to generate and output reference sine-wave signal r1[n] and reference cosine-wave signal r2[n].

First one-tap digital filter 107 filters x1[n] according to filter coefficient W1[n] retained inside it to generate first control signal y1[n]. Second one-tap digital filter 108 filters reference cosine-wave signal x2[n] according to filter coefficient W2[n] retained inside it to generate second control signal y2[n].

Power amplifier 109 amplifies a signal produced by adding first control signal y1[n] to second control signal y2[n]. Speaker 110 outputs an output signal from power amplifier 109 as noise canceling sound. Microphone 111 detects sound resulting from the interference of noise with noise canceling sound as error signal ε[n].

First adaptive control algorithm operating unit 112 successively updates filter coefficient W1[n] according to reference sine-wave signal r1[n] and error signal ε[n] on the basis of such as LMS (least mean square) algorithm (a type of steepest descent method). Similarly, second adaptive control algorithm operating unit 113 successively updates filter coefficient W2[n] according to reference cosine-wave signal r2[n] and error signal ε[n].

Repeating the above-described process in a given cycle reduces noise.

In the above-described conventional configuration, however, generating reference sine-wave signal r1[n] and reference cosine-wave signal r2[n] involves a product-sum operation of reference sine-wave signal x1[n] with reference sine-wave signal correction value C1[f] and that of reference cosine-wave signal x2[n] with reference cosine-wave signal correction value C2[f], requiring two times of product operations to produce respective reference signals, which increases the operation load.

[Patent literature 1] Japanese Patent Unexamined Publication No. 2004-361721

### SUMMARY OF THE INVENTION

The present invention provides an active noise controller reducing the operation load required for noise-canceling control by minimizing the number of times of executing product operations.

An active noise controller of the present invention is composed of a control-target noise frequency detector detecting the frequency of noise to be controlled caused by a noise source; a sine wave generator generating a sine wave with its frequency same as that of noise detected by the control-target noise frequency detector; a cosine wave generator generating a cosine wave with its frequency same as that of noise detected by the control-target noise frequency detector; a first one-tap digital filter into which a sine-wave signal from the sine wave generator is input; a second one-tap digital filter into which a cosine-wave signal from the cosine wave generator is input; a drive signal generator into which data produced by adding output from the first one-tap digital filter to the second one is input, to output a drive signal to make interfere with noise to be controlled caused by a noise source; an error signal detector detecting an error signal caused by the interference between a drive signal output from the drive signal generator and noise to be controlled caused by a noise source; a first coefficient updater updating the filter coefficient of the first one-tap digital filter; and a second coefficient updater updating the filter coefficient of the second one-tap digital filter. The first and second coefficient updaters update the coefficients of the first and second one-tap digital filters so that noise at the error signal detector is reduced, according to an error signal from the error signal detector and the respective reference signals for an isosceles triangle wave with its basic frequency same as that of noise detected by the control-target noise frequency detector.

In this way, when the reference signal is an isosceles triangle wave, a value related to the phase characteristic of the transmission characteristic of from the drive signal generator to the error signal detector is determined without a product operation required. Hence, the operation load is reduced.

When the reference signal is a square wave or isosceles trapezoid wave, the operation load is reduced as well.

### BRIEF DESCRIPTION OF DRAWINGS

FIG. 1 is a block diagram illustrating the configuration of an active noise controller according to the first exemplary embodiment of the present invention.

FIG. 2 is a characteristic diagram showing an example sine wave table included in the active noise controller according to the first embodiment of the present invention.

FIG. 3 shows an example sine wave table included in the active noise controller according to the first embodiment of the present invention.

FIG. 4A is a characteristic diagram showing the transmission characteristic of from the speaker to the microphone of the active noise controller according to the first embodiment of the present invention.

FIG. 4B is a characteristic diagram showing the transmission characteristic of from the speaker to the microphone of the active noise controller according to the first embodiment of the present invention.

FIG. 5A shows an example amplitude characteristic array corresponding to the transmission characteristic of from the speaker to the microphone of the active noise controller according to the first embodiment of the present invention.

FIG. 5B shows an example phase characteristic equivalent array corresponding to the transmission characteristic of from the speaker to the microphone of the active noise controller according to the first embodiment of the present invention.

FIG. 6A is a characteristic diagram showing a time-base waveform of an isosceles triangle wave.

FIG. 6B is a characteristic diagram showing a time-base waveform of a square wave.

FIG. 6C is a characteristic diagram showing a time-base waveform of an isosceles trapezoid wave.

FIG. 6D is a characteristic diagram showing harmonic analysis of an isosceles triangle wave.

FIG. 6E is a characteristic diagram showing harmonic analysis of a square wave.

FIG. 6F is a characteristic diagram showing harmonic analysis of an isosceles trapezoid wave.

FIG. 7 is a block diagram illustrating the configuration of a conventional active noise reduction apparatus.

### REFERENCE MARKS IN THE DRAWINGS

1 Engine rotation speed detector
2 Frequency detector (control-target noise frequency detector)
3 Sine wave table
4 Characteristic table
5 Sine wave generator
6 Cosine wave generator
7 First one-tap digital filter
8 Second one-tap digital filter
9 Power amplifier
10 Speaker (drive signal generator)
11 Microphone (error signal detector)
12 First adaptive control algorithm operating unit (first coefficient updater)
13 Second adaptive control algorithm operating unit (second coefficient updater)
14 Reference signal generator
15 Discrete operation processing unit

### DETAILED DESCRIPTION OF PREFERRED EMBODIMENTS

### First Exemplary Embodiment

Hereinafter, a description is made for an active noise reduction apparatus according to the first exemplary embodiment of the present invention, with reference to the related drawings.

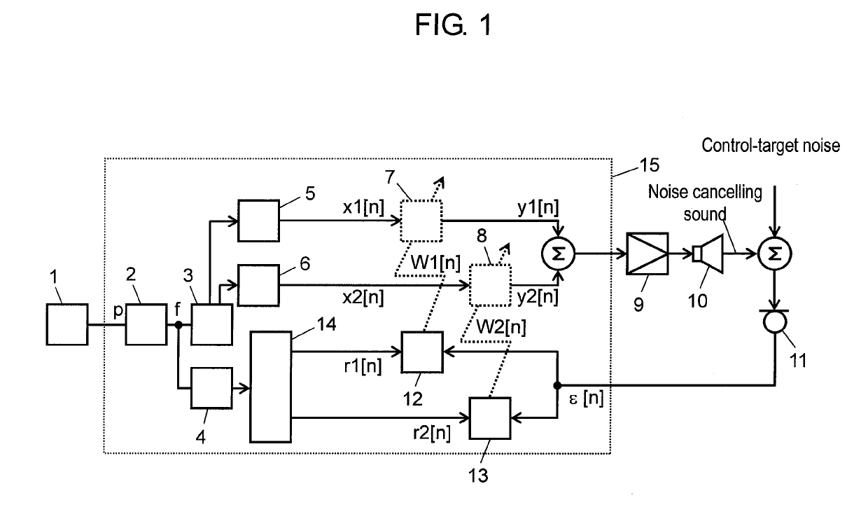

FIG. 1 is a block diagram of an active noise reduction apparatus according to the first embodiment of the present invention. In FIG. 1, engine rotation speed detector 1 outputs a pulse string with its frequency proportional to the rotation speed of the engine (i.e. a noise source incorporated into a vehicle) as engine pulses p. Frequency detector 2 (i.e. control-target noise frequency detector) calculates control-target noise frequency f (Hz) from engine pulses p and outputs the frequency. Sine wave table 3 including sine wave data discretized retains on a memory sine values at respective points given by equally dividing one cycle of sine wave by N.

Sine wave generator 5 reads data from sine wave table 3 at every sampling cycle at given intervals according to control-target noise frequency f to generate reference sine-wave signal x1[n]. Similarly, cosine wave generator 6 reads data from sine wave table 3 at every sampling cycle at given intervals according to control-target noise frequency f. Then, cosine wave generator 6 generates reference cosine-wave signal x2[n] by reading a point preceding sine wave generator 5 by N/4 at the same time point. A read point exceeding N takes a value produced by subtracting N from the read point as a new read point.

Characteristic table 4 retains phase characteristic equivalent P[f] with respect to each frequency. Phase characteristic equivalent P[f] is obtained by converting amplitude characteristic G[f] and the phase characteristic (i.e. transmission characteristic of from speaker 10 to microphone 11) to a point displacement relative to the number of points N stored in sine wave table 3. Reference signal generator 14 reads amplitude characteristic G[f] and phase characteristic equivalent P[f] at control-target noise frequency f from characteristic table 4 according to control-target noise frequency f. Then, reference signal generator 14 generates sine-wave reference signal r1[n] and cosine-wave reference signal r2[n] composed of an isosceles triangle wave, square wave, or isosceles trapezoid wave, according to G[f] and P[f].

Next, first one-tap digital filter 7 retains inside it first filter coefficient W1[n] and outputs first control signal y1[n] according to reference sine-wave signal x1[n] and first filter coefficient W1[n]. Second one-tap digital filter 8 retains inside it second filter coefficient W2[n] and outputs second control signal y2[n] according to reference cosine-wave signal x2[n] and second filter coefficient W2[n].

Power amplifier 9 amplifies a signal produced by adding first control signal y1[n] to second control signal y2[n]. Speaker 10 as a drive signal generator outputs an output signal from power amplifier 9 as noise canceling sound. Microphone 11 as an error signal detector detects sound resulting from the interference of control-target noise caused by engine vibration with noise canceling sound, as error signal ε[n].

First adaptive control algorithm operating unit 12 (i.e. first coefficient updater) successively updates filter coefficient W1[n] of first one-tap digital filter 7 according to sine-wave reference signal r1[n] and error signal ε[n]. Second adaptive control algorithm operating unit 13 (i.e. second coefficient updater) successively updates filter coefficient W2[n] of second one-tap digital filter 8 according to cosine-wave reference signal r2[n] and error signal ε[n]. Discrete operation processing unit 15 is thus implemented by software.

Next, a description is made for concrete operation of the apparatus.

Here, generating reference sine-wave signal x1[n], reference cosine-wave signal x2[n], sine-wave reference signal r1[n], cosine-wave reference signal r2[n], first control signal y1[n], and second control signal y2[n]; detecting error signal ε[n]; and updating filter coefficient W1[n] and filter coefficient W2[n] - - - all are executed in the same cycle. Hereinafter, a description is made assuming the cycle is T (seconds).

Frequency detector 2 generates an interrupt at every rising edge of engine pulses p, for example; measures time between rising edges; and calculates frequency f of control-target noise according to the measurement result.

Sine wave table 3 divides one cycle of sine wave equally by N and retains on a memory discrete data of a sine value at each point. When an array storing sine values from 0th point to (N−1)th point is represented with z[m] (0≦m≦N), relational expression (1) holds.

z[m]=sin(360°×m/N) (1)

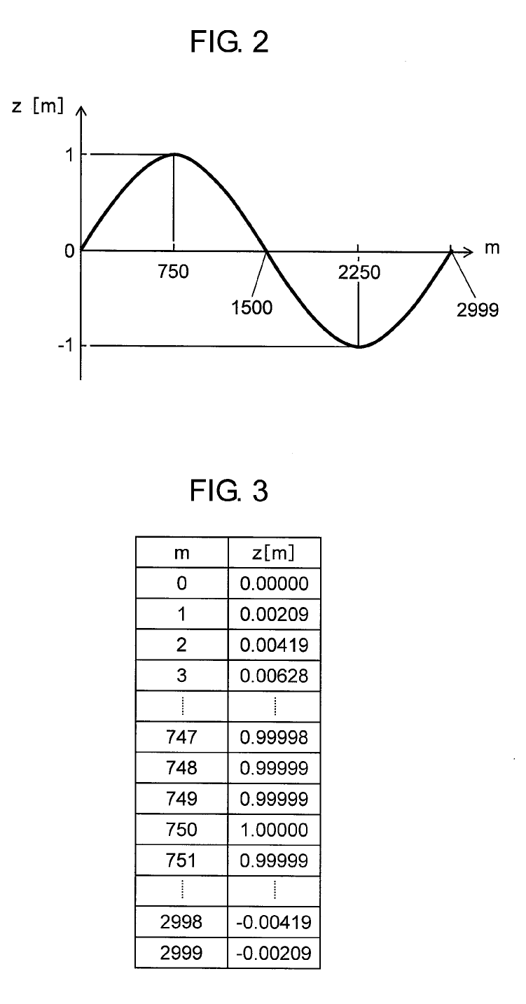

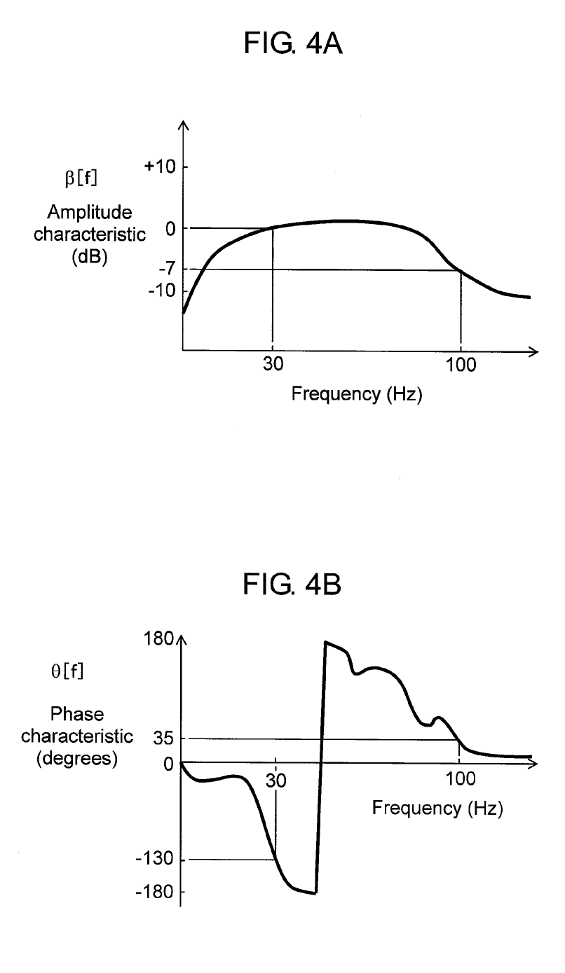

FIGS. 2 and 3 are a characteristic diagram and table showing an example sine wave table included in the active noise controller according to the first embodiment of the present invention. FIG. 2 shows a graph of z[m] when N=3000 and FIG. 3 shows values of z[m] when N=3000.

Characteristic table 4 retains on a memory amplitude characteristic array G[f] representing the amplitude characteristic (i.e. transmission characteristic of from speaker 10 to microphone 11) and phase characteristic equivalent array P[f] (i.e. array obtained by converting the phase characteristic to a point displacement relative to the number of points N stored in sine wave table 3), where f represents frequency (Hz).

Assuming the amplitude characteristic is β[f] (dB) and phase characteristic is θ[f] (degrees) when the frequency is f (Hz), the following relational expressions (2-1) and (2-2) hold.

G[f]=10̂(β[f]/20) (2-1)

P[f]=N×θ[f]/360 (2-2)

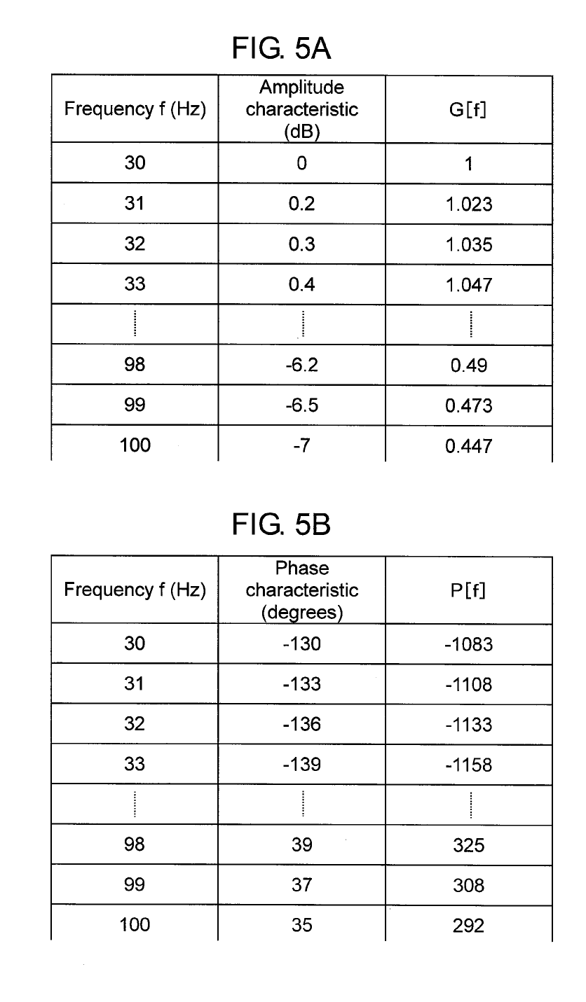

FIGS. 4A, 4B are characteristic diagrams showing an example transmission characteristic of from the speaker to the microphone of the active noise controller according to the first embodiment of the present invention. FIG. 4A shows an example of amplitude characteristic β[f] with a control-target noise frequency between 30 Hz and 100 Hz at N=3000. FIG. 4B shows an example of phase characteristic θ[f] with a control-target noise frequency between 30 Hz and 100 Hz at N=3000.

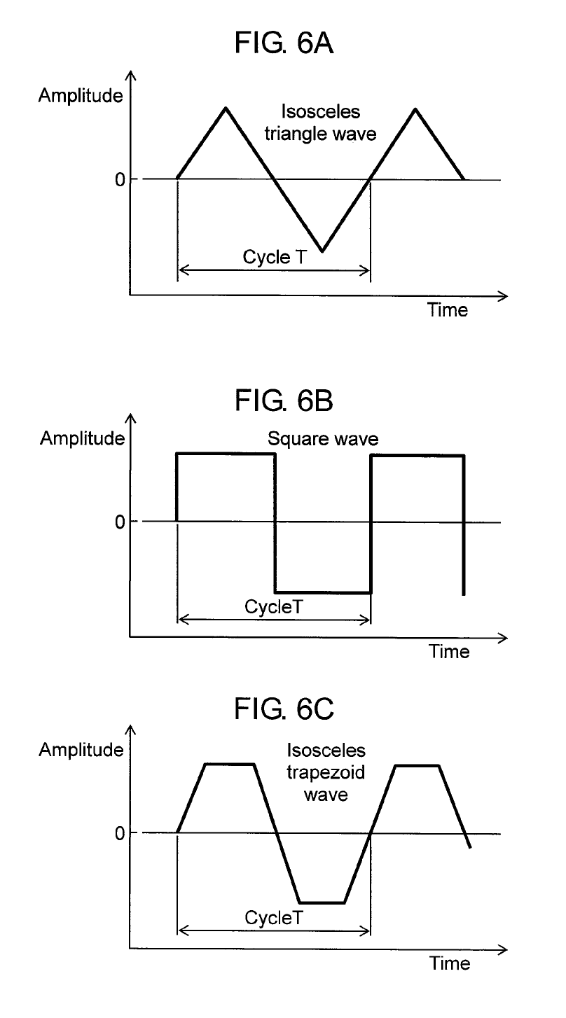

FIG. 5A shows an example amplitude characteristic array corresponding to the transmission characteristic of from the speaker to the microphone of the active noise controller according to the first embodiment of the present invention, namely amplitude characteristic array G[f] corresponding to amplitude characteristic β[f] of FIG. 4A. FIG. 5B shows an example phase characteristic equivalent array corresponding to the transmission characteristic of from the speaker to the microphone of the active noise controller according to the first embodiment of the present invention, namely phase characteristic array P[f] corresponding to phase characteristic θ[f] of FIG. 4B.

Sine wave generator 5 stores on a memory current read position i[n] of sine wave table 3 and moves the current read position at every cycle according to control-target noise frequency f on the basis of expression (3)

i[n+1]=i[n]+N×f×T (3)

However, if the calculation result of the right-hand side of expression (3) is N or more, a value produced by subtracting N from the calculation result of the right-hand side is to be i[n+1].

Simultaneously, sine wave generator 5 generates reference sine-wave signal x1[n] with its frequency same as control-target noise frequency f from expressions (4), (5).

ix1=i[n] (4)

x1[n]=z[ix1] (5)

However, if the calculation result of the right-hand side of expression (4) is N or more, a value produced by subtracting N from the calculation result of the right-hand side is to be ix1.

Cosine wave generator 6 generates reference cosine-wave signal x2[n] with its frequency same as control-target noise frequency f and additionally with its phase preceding reference sine-wave signal x1[n] by one-quarter cycle from expressions (6), (7).

ix2=i[n]+N/4 (6)

x2[n]=z[ix2] (7)

However, if the calculation result of the right-hand side of expression (6) is N or more, a value produced by subtracting N from the calculation result of the right-hand side is to be ix2.

Reference signal generator 14 extracts from characteristic table 4 as G[f] and P[f], an amplitude characteristic value (i.e. transmission characteristic of from speaker 10 to microphone 11 at control-target noise frequency f) and a phase characteristic equivalent (i.e. a value obtained by converting the phase characteristic to a point displacement relative to the number of points N stored in sine wave table 3), to produce sine-wave reference signal r1[n] and cosine-wave reference signal r2[n] by the following method.

### 1. When the Reference Signal is an Isosceles Triangle Wave

Sine-wave reference signal r1[n] is given by the following expression, where ix3=ix1+P[f]. (however, when ix1+P[f] exceeds N, ix3=ix1+P[f]−N)

if ix3≦N/4,

r1[n]=ix3×G[f] (8-1)

if N/4<ix3<N×3/4,

r1[n]=(N/2−ix3)×G[f] (8-2)

if ix3>N×3/4,

r1[n]=(ix3−N)×G[f] (8-3)

In the same way, cosine-wave reference signal r2[n] is given by the following expression, where ix4=ix2+P[f]. (however, when ix2+P[f] exceeds N, ix4=ix2+P[f]−N)

if ix4≦N/4,

r2[n]=ix4×G[f] (8-4)

if N/4<ix4≦N×3/4,

r2[n]=(N/2−ix4)×G[f] (8-5)

if ix4>N×3/4,

r2[n]=(ix4−N)×G[f] (8-6)

### 2. When the Reference Signal is a Square Wave

Sine-wave reference signal r1[n] is given by the following expression, where ix3=ix1+P[f]. (however, when ix1+P[f] exceeds N, ix3=ix1+P[f]−N)

if ix3≦N/2,

r1[n]=A×G[f] (9-1)

if ix3>N/2,

r1[n]=−A×G[f] (9-2)

In the same way, cosine-wave reference signal r2[n] is given by the following expression, where ix4=ix2+P[f]. (however, when ix2+P[f] exceeds N, ix4=ix2+P[f]−N)

if ix4≧N/2,

r2[n]=A×G[f] (9-3)

if ix4>N/2,

r2[n]=−A×G[f] (9-4)

Here, A is an arbitrary value.

### 3. When the Reference Signal is an Isosceles Trapezoid Wave

This case is an isosceles triangle wave with its top and bottom limited with a certain constant value, where the limit value is assumed to be ±B.

Sine-wave reference signal r1[n] is given by the following expression, where ix3=ix1+P[f]. (however, if ix1+P[f] exceeds N, ix3=ix1+P[f]−N)

if ix3≧N/4,

if ix3≧B,r1[n]=ix3×G[f] (10-1)

if ix3>B,r1[n]=B×G[f] (10-2)

if N/4<ix3<N×3/4,

if |N/2−ix3|≧B,

r1[n]=(N/2−ix3)×G[f] (10-3)

if (N/2−ix3)>B,

r1[n]=B×G[f] (10-4)

if (N/2−ix3)<−B,

r1[n]=−B×G[f] (10-5)

if ix3>N×3/4,

if (ix3−N)>−B,

r1[n]=(ix3−N)×G[f] (10-6)

if (ix3−N)<−B,

r1[n]=−B×G[f] (10-7)

In the same way, cosine-wave reference signal r2[n] is given by the following expression, where ix4=ix2+P[f]. (however, ix2+P[f] exceeds N, ix4=ix2+P[f]−N)

if ix4≦N/4,

if ix4≦B.

r2[n]=ix4×G[f] (10-8)

if ix4>B,

r2[n]=B×G[f] (10-9)

if N/4<ix4≦N×3/4,

if |N/2−ix4|≦B,

r2[n]=(N/2−ix4)×G[f] (10-10)

if (N/2−ix4)>B,

r2[n]=B×G[f] (10-11)

if (N/2−ix4)<−B,

r2[n]=−B×G[f] (10-12)

if ix4>N×3/4,

if (ix4−N)>−B,

r2[n]=(ix4−N)×G[f] (10-13)

if (ix4−N)<−B,

r2[n]=−B×G[f] (10-14)

Thus, r1[n],r2[n] are generated.

First and second one-tap digital filters 7, 8 generate first and second control signals y1[n], y2[n] from expressions (12), (13), respectively.

y1[n]=W1[n]×x1[n] (11)

y2[n]=W2[n]×x2[n] (12)

First and second adaptive control algorithm operating units 12, 13 update filter coefficients W1[n],W 2[n] retained by first and second one-tap digital filters 7, 8 by LMS (least mean square) algorithm (a type of steepest descent method), for example, from expressions (13), (14), respectively.

W1[n+1]=W1[n]−μ×ε[n]×r1[n] (13)

W2[n+1]=W2[n]−μ×ε[n]×r2[n] (14)

Here, μ is a step size parameter, determining the convergence rate in steepest descent method.

Converging filter coefficients W1[n], W2[n] on the basis of the above-described procedure reduces control-target noise.

Here, a sine wave is typically used as a reference signal. However, even if an isosceles triangle wave, square wave, or isosceles trapezoid wave is used as a reference signal, which is a feature of the present invention, target noise with frequency f is reduced in the same way as that of a sine wave. Such mechanism is described next.

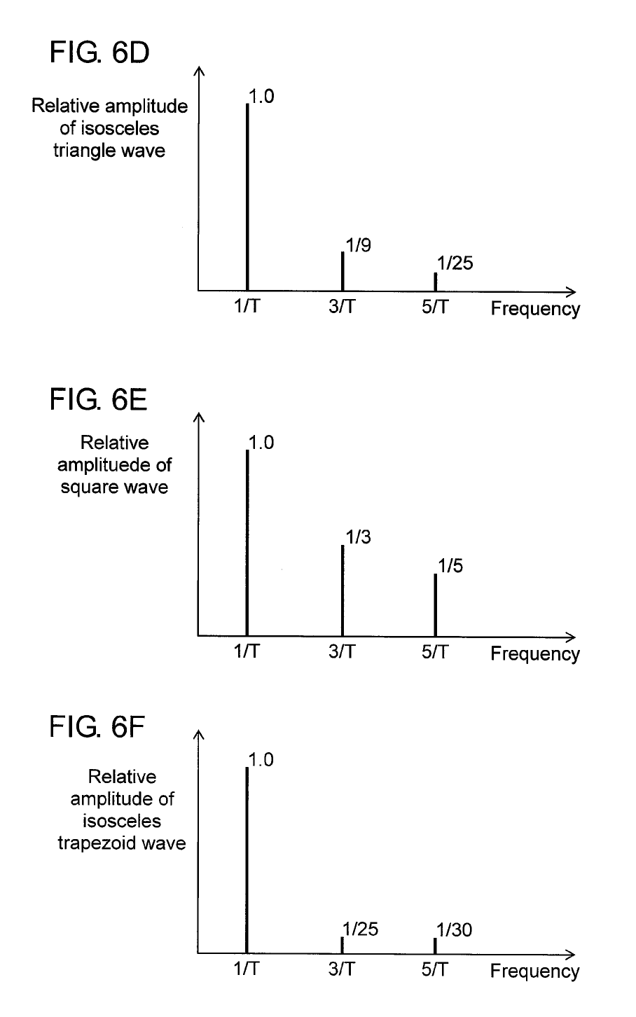

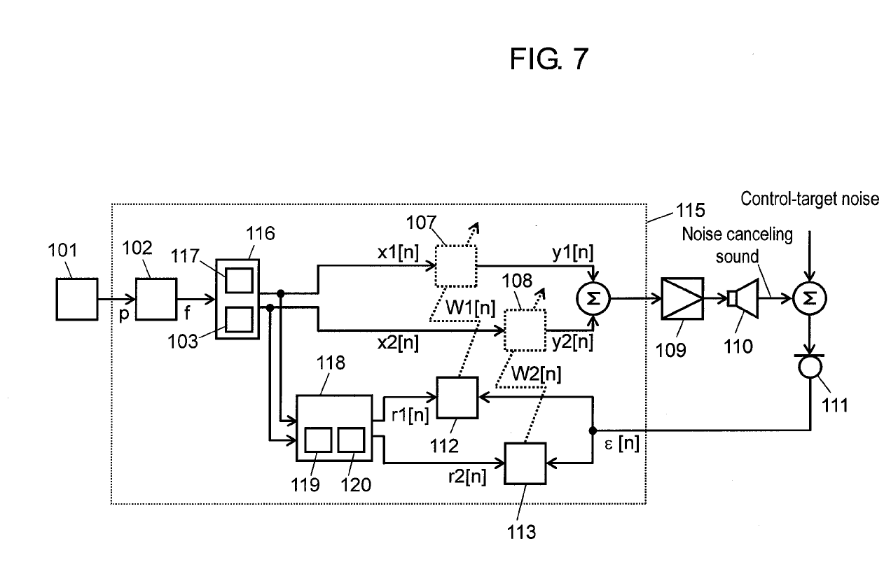

FIG. 6A is a characteristic diagram showing a time-base waveform of an isosceles triangle wave. FIG. 6B is a characteristic diagram showing a time-base waveform of a square wave. FIG. 6C is a characteristic diagram showing a time-base waveform of an isosceles trapezoid wave. FIG. 6D is a characteristic diagram showing harmonic analysis of an isosceles triangle wave. FIG. 6E is a characteristic diagram showing harmonic analysis of a square wave. FIG. 6F is a characteristic diagram showing harmonic analysis of an isosceles trapezoid wave.

FIGS. 6A through 6F indicate each wave is composed of its basic frequency component and odd-order harmonics, which is expressed by the next expressions.

r1[n]=A1 Sin(2πfn/T)+A2 Sin(2πf3n/T)+A3 Sin(2πf5n/T)+ (15)

r2[n]=A1 Cos(2πfn/T)+A2 Cos(2πf3n/T)+A3 Cos(2πf5n/T)+ (16)

Meanwhile, deforming coefficient update expressions (13), (14) for a digital filter give the following expressions.

ΔW1=W1[n+1]−W1[n]=−μ×ε[n]×r1[n]

ΔW2=W2[n+1]−W2[n]=−μ×ε[n]×r2[n]

W1=ΣΔW1=ε(−μ×ε[n]×r1[n]) (17)

W2=ΣΔW2=Σ(−μ×ε[n]×r2[n]) (18)

W1, W2 are proportional to the cumulatives of (−μ×ε[n]×r1[n]) and (−μ×ε[n]×r2[n]).

If ε[n] is a sine wave (Sin(2πfn/T)) with frequency f, W1 is given from expressions (15), (17).

$$\begin{matrix}W 1 = \sum ( - μ \times ɛ [ n ] \times r 1 [ n ] ) \\ = \sum \{ - μ \times Sin ( 2 π fn / T ) \times ( A 1 Sin ( 2 π fn / T ) + \\ A 2 Sin ( 2 π f 3 n / T ) + A 3 Sin ( 2 π f 5 n / T ) + … ) \}\end{matrix}$$

Since a sine wave has orthogonality, the cumulative of components with different frequencies becomes zero, and thus

$$\begin{matrix}W 1 = \sum ( - μ \times ɛ [ n ] \times r 1 [ n ] ) \\ = \sum ( - μ \times Sin ( 2 π fn / T ) \times A 1 Sin ( 2 π fn / T ) [ n ] )\end{matrix} \qquad ( 19 )$$

The situation is completely the same with W2, thus indicating both W1 and W2 represent the values equivalent to that of a case where a sine wave is used as a reference signal. That is, in the same way as in a case where a sine wave is used as a reference signal, in a case where an isosceles triangle wave, square wave, or isosceles trapezoid wave is used as a reference signal, target noise with frequency f is reduced as well.

When ε[n] includes, other than a sine wave (Sin(2πfn/T)) with frequency f, its harmonic (e.g. B1 Sin(2πf3n/T), the third-order component), the cumulative of the product occurs of B1 Sin(2πf3n/T), the third-order component of the noise, and A2 Sin(2πf3n/T), the third-order component contained in the reference signal, resulting in being different from the cumulative of a case where the reference signal is a sine wave with frequency f.

$$\begin{matrix}W 1 = \sum ( - μ \times ɛ [ n ] \times r 1 [ n ] ) \\ = \sum ( - μ \times Sin ( 2 π fn / T ) \times A 1 Sin ( 2 π fn / T ) ) + \\ \sum ( - μ \times B 1 Sin ( 2 π f 3 n / T ) \times A 2 Sin ( 2 π f 3 n / T ) )\end{matrix} \qquad ( 20 )$$

However, as shown in FIGS. 6D, 6E, 6F, higher-order components contained in the reference signal are smaller than the fundamental component, namely A1>A2. Noise is supposed to tend to have higher-order components less than the fundamental component, namely A1>B1, and thus the next expression holds, which means there is no practical problem.

Σ(−μ×Sin(2πfn/T)×A1 Sin(2πfn/T)[n])>>(−μ×B1 Sin(2πf3n/T)×A2 Sin(2πf3n/T)[n])

Especially, an isosceles trapezoid wave has harmonic components (especially third-order harmonics) small enough as compared to the fundamental as shown in FIG. 6F, thus producing the smallest error.

Here, comparison is made between the present invention and the method described in patent literature 1 on how to generate reference sine-wave signal r1[n] and reference cosine-wave signal r2[n] from the aspect of the operation load. In the method described in patent literature 1, reference sine-wave signal r1[n] and reference cosine-wave signal r2[n] are generated from expressions (21), (22) shown below with the aid of reference sine-wave signal correction value table 119 (the reference sine-wave signal correction value at frequency f (Hz) is represented as C1[f]) and reference cosine-wave signal correction value table 120 (the reference cosine-wave signal correction value at frequency f (Hz) is represented as C2[f]), both simulating the transmission characteristic value of from speaker 10 to microphone 11.

r1[n]=C1[f]×x1[n]+C2[f]×x2[n] (21)

r2[n]=C1[f]×x2[n]−C2[f]×x1[n] (22)

While expressions (21), (22) involve two times of multiplication, the present invention requires only one multiplication as described in expressions (8-1) through (8-6), (9-1) through (9-4), and (10-1) through (10-14). Here, the present invention reduces the operation load compared to the method described in patent literature 1.

In the present invention, the description is made for the case where the reference cosine-wave signal is x2[n], which is input to the second one-tap digital filter. However, the phase difference between x1[n] and x2[n] is not limited to 90°, but a slight error is allowed.

Providing more than one components of first and second one-tap digital filters 7, 8; first and second adaptive control algorithm operating units 12, 13, respectively enable canceling plural orders of components of control-target noise.

### INDUSTRIAL APPLICABILITY

An active noise controller of the present invention reduces operation load by minimizing the number of execution times of product-sum operations, which is useful as a low-cost, practical controller.

1. An active noise controller comprising:
a control-target noise frequency detector detecting a frequency of noise to be controlled caused by a noise source;
a sine wave generator generating a sine wave with a frequency same as that of the noise detected by the control-target noise frequency detector;
a cosine wave generator generating a cosine wave;
a first one-tap digital filter into which a sine-wave signal from the sine wave generator is input;
a second one-tap digital filter into which a cosine-wave signal from the cosine wave generator is input;
a drive signal generator into which a signal produced by adding output from the first one-tap digital filter to output from the second one-tap digital filter is input, to output a drive signal to make interfere with the noise;
an error signal detector detecting an error signal resulting from interference of the drive signal output from the drive signal generator with the noise;
a first coefficient updater updating a filter coefficient of the first one-tap digital filter;
a second coefficient updater updating a filter coefficient of the second one-tap digital filter,
wherein the first coefficient updater and second coefficient updater update coefficients of the first one-tap digital filter and the second one-tap digital filter so that noise at the error signal detector is reduced, according to an error signal from the error signal detector and respective reference signals for an isosceles triangle wave with a basic frequency same as that of noise detected by the control-target noise frequency detector.

2. The active noise controller of claim 1,
wherein the first coefficient updater and the second coefficient updater update coefficients of the first one-tap digital filter and the second one-tap digital filter so that noise at the error signal detector is reduced, according to an error signal from the error signal detector and respective reference signals for a square wave with a basic frequency same as that of noise detected by the control-target noise frequency detector.

3. The active noise controller of claim 1,
wherein the first coefficient updater and the second coefficient updater update coefficients of the first one-tap digital filter and the second one-tap digital filter so that noise at the error signal detector is reduced, according to an error signal from the error signal detector and respective reference signals for an isosceles trapezoid wave with a basic frequency same as that of noise detected by the control-target noise frequency detector.
